(19) United States
(12) Patent Application Publication
(10) Pub. No.: US 2023/0325659 A1
(43) Pub. Date: Oct. 12, 2023

(54) SYSTEM AND METHOD FOR AVOIDING CATASTROPHIC FORGETTING IN AN ARTIFICIAL NEURAL NETWORK

(71) Applicants: Commissariat à I'Énergie Atomique et aux Énergies Alternatives, Paris (FR); Universite Grenoble Alpes, Saint Martin D'heres (FR); Centre National de la Recherche Scientifique, PARIS (FR); Université de Chambéry - Université Savoie Mont Blanc, Chambery Cedex (FR)

(72) Inventors: Miguel-Angel Solinas, Grenoble Cedex 9 (FR); Martial Mermillod, Grenoble Cedex 9 (FR); Marina REyboz, Grenoble Cedex 9 (FR); Stephane Rousset, Grenoble Cedex 9 (FR)

(73) Assignees: Commissariat à I'Énergie Atomique et aux Énergies Alternatives, Paris (FR); Universite Grenoble Alpes, Saint Martin D'heres (FR); Centre National de la Recherche Scientifique, Paris (FR); Université de Chambéry - Université Savoie Mont Blanc, Chambery Cedex (FR)

(21) Appl. No.: 18/024,242

(22) PCT Filed: Sep. 8, 2021
(86) PCT No.: PCT/EP2021/074639

§ 371 Date: Mar. 1, 2023

(30) Foreign Application Priority Data
Sep. 11, 2020 (FR) 2009220

(51) Int. Cl. G06N 3/08

(52) U.S. Cl. CPC G06N 3/08

(57) ABSTRACT

A method of training an artificial neural network, the method comprising: initially training a first artificial neural network with first input data and first pseudo data, wherein the first pseudo data is or was generated by a second artificial neural network in a virgin state, or by the first artificial neural network while in a virgin state; generating second pseudo data using the first artificial neural network, or using the second artificial neural network following at least partially transferring knowledge from the first artificial neural network to the second artificial neural network; and training the first artificial neural network, or another artificial neural network, with the second pseudo data and second input data.

The present patent application claims priority from the French patent application filed on Sep. 11, 2020 and assigned application no. FR2009220, the contents of which is hereby incorporated by reference.

### TECHNICAL FIELD

The present disclosure relates generally to the field of artificial neural networks, and in particular to a system and method for avoiding catastrophic forgetting in an artificial neural network and/or for allowing incremental learning.

### BACKGROUND ART

Artificial neural networks (ANNs) are architectures that aim to mimic, to some extent, the behavior of a human brain. Such networks are generally formed of neuron circuits, and interconnections between the neuron circuits, known as synapses.

As known by those skilled in the art, ANN architectures, such as multi-layer perceptron architectures, or deep neural networks, including convolutional neural networks, comprise an input layer of neuron circuits, one or more hidden layers of neuron circuits, and an output layer of neuron circuits. Each of the neuron circuits in the hidden layer or layers applies an activation function, (for instance a sigmoid function) to inputs received from the previous layer in order to generate an output value. The inputs are weighted by trainable parameters θ at the inputs of the neurons of the hidden layer or layers. While the activation function is generally selected by the designer, the parameters θ are found during training.

For a given problem, a function to be approximated is for example one that generates, based on inputs X, true output labels yₜ=F(x), where F(x) is an unknown function that maps observation (X) to categories (Y). The trained network yₚ=ƒ(x;θ) is trained to generate a value yₚ that is as close as possible to the true value yₜ by minimizing a loss function between the desired outputs (yₜ) and the predicted outputs (yₚ). The performance of a trained ANN in solving the task being learnt lies on its architecture, the number of parameters θ, the particular implementation, and how the ANN is trained (learning rate and optimizer).

While deep learning has yielded remarkable results in a wide range of applications, it can struggle in realistic scenarios when the distribution of training data only becomes available over the course of training. Indeed, it is generally desired that an ANN is capable of easily adapting to learn new information, but a drawback of this plasticity is that it is often difficult to build upon a trained model while conserving a mapping function that has already been learnt. The tendency of ANNs to forget completely and abruptly previously learned information upon learning new information is known in the art as catastrophic forgetting.

While a solution could be to store all, or some, historic training data in a buffer and to present the ANN with a mix of the historic training data interspersed with a new information, such an approach would involve the use of a memory in order to store the historic training data. Therefore, this is not a practical solution for resource frugal applications.

There is thus a need for a system and method for addressing the catastrophic forgetting problem during the training of an ANN.

### SUMMARY OF INVENTION

It is an aim of embodiments of the present disclosure to at least partially address one or more needs in the prior art.

According to one aspect, there is provided a method comprising: training an artificial neural network by: initially training a first artificial neural network with first input data and first pseudo data, wherein the first pseudo data is or was generated by a second artificial neural network in a virgin state, or by the first artificial neural network while in a virgin state; generating second pseudo data using the first artificial neural network, or using the second artificial neural network following at least partially transferring knowledge from the first artificial neural network to the second artificial neural network; and training the first artificial neural network, or another artificial neural network, with the second pseudo data and second input data; using the trained first or further artificial neural network in a hardware system to control one or more actuators.

According to one embodiment, the method further comprises, prior to initially training the first artificial neural network: generating the first pseudo data using the first artificial neural network while in the virgin state; and storing the first pseudo data to a memory.

According to one embodiment, the second pseudo data is generated by the first artificial neural network and stored to the memory prior to training the first artificial neural network with the second pseudo data and the second input data.

According to one embodiment, the method further comprises, prior to generating the second pseudo data, at least partially transferring knowledge held by the first artificial neural network to the second artificial neural network, wherein the second pseudo data is generated using the second artificial neural network, wherein the training of the first artificial neural network with the second pseudo data and second input data is performed at least partially in parallel with the generation of pseudo data by the second artificial neural network.

According to one embodiment, the method further comprises: detecting, using a novelty detector, whether one or more third input data samples correspond to a class that is already known to the first artificial neural network; and if the one or more third input data samples do not correspond to a class that is already known, generating third pseudo data using the first artificial neural network, or using the second artificial neural network following at least partially transferring knowledge again from the first artificial neural network to the second artificial neural network, and training the first artificial neural network with the third pseudo data and third input data samples.

According to one embodiment, the method further comprises: detecting, by a controller, whether one or more third input data samples correspond to a new distribution not already learnt by the first artificial neural network; and if the one or more third input data samples do correspond to the new distribution, creating a new system for learning the one or more third input data samples, the new system comprising at least a further first artificial neural network.

According to one embodiment, generating the first pseudo data comprises: a) injecting a first random sample into the first or second artificial neural network, wherein the first or second artificial neural network is configured to implement at least an auto-associative function ƒ or replicating input samples at one or more of its outputs, at least some of the replicated input samples present at the outputs forming the first pseudo data.

According to one embodiment, generating the second pseudo data comprises: a) injecting a second sample into the first or second artificial neural network, wherein the first or second artificial neural network is configured to implement at least an auto-associative function ƒ or replicating input samples at one or more of its outputs, at least some of the replicated input samples present at the outputs forming the second pseudo data, wherein the first sample is a random sample or a real sample.

According to one embodiment, generating the first and/or second pseudo data further comprises: b) reinjecting a pseudo sample, generated based on the replicated sample present at the one or more outputs of the first or second artificial neural network, into the first or second artificial neural network in order to generate a new replicated sample at the one or more outputs; and c) repeating b) one or more times to generate a plurality of reinjected pseudo samples, . . . ); wherein the first and/or second pseudo data comprises at least two of said reinjected pseudo samples, . . . ) originating from the same first or second sample and corresponding output values generated by the first or second artificial neural network.

According to one embodiment, generating the first and/or second pseudo data further comprises: b) reinjecting a pseudo sample, generated based on the replicated sample present at the one or more outputs of the first or second artificial neural network, into the first or second artificial neural network in order to generate a new replicated sample at the one or more outputs; and c) repeating b) one or more times to generate a plurality of reinjected pseudo samples; wherein the first and/or second pseudo data comprises at least two of said reinjected pseudo samples originating from the same first or second sample and corresponding output values generated by the first or second artificial neural network.

According to one embodiment, the first and/or second artificial neural network implements a learning function, which is for example a classification function, and the corresponding output values of the first pseudo data comprise pseudo labels generated by the learning function based on the reinjected pseudo samples.

According to one embodiment, using the trained first or further artificial neural network to control one or more actuators comprises: providing, by one or more sensors, one or more third input data samples to a novelty detector; detecting whether the one or more third input data samples correspond to a class that is already known to the first artificial neural network, and if so, providing the third input data samples to an inference module comprising the trained first or further artificial neural network in order to generate a predicted label for controlling the one or more actuators.

According to one embodiment, the method further comprises, if the one or more third input data samples do not correspond to a class that is already known to the first artificial neural network generating third pseudo data using the first artificial neural network, or using the second artificial neural network following at least partially transferring knowledge again from the first artificial neural network to the second artificial neural network; and training the first artificial neural network with the third pseudo data and third input data samples.

According to a further aspect, there is provided a system comprising: a first artificial neural network; either a second artificial neural network in a virgin state and configured to generate first pseudo data, or a memory storing the first pseudo data generated by the first artificial neural network while in a virgin state; one or more actuators; and one or more circuits or processors configured to generate old memories for use in training the first artificial neural network by: initially training the first artificial neural network with first input data and with the first pseudo data; generating second pseudo data using the first artificial neural network, or using the second artificial neural network following at least partially transferring knowledge from the first artificial neural network to the second artificial neural network; and training the first artificial neural network, or another artificial neural network, with the second pseudo data and second input data and controlling the one or more actuators using the trained first or further artificial neural network.

According to one embodiment, the system further comprising a novelty detector configured to: detect whether one or more third input data samples correspond to a class that is already known to the first artificial neural network; wherein, if the one or more third input data samples do not correspond to a class that is already known, the one or more circuits or processors is further configured to: generate third pseudo data using the first artificial neural network, or using the second artificial neural network following at least partially transferring knowledge again from the first artificial neural network to the second artificial neural network; and training the first artificial neural network with the third pseudo data and third input data samples.

According to one embodiment, the system further comprises one or more sensors configured to provide the one or more third input data samples.

According to one embodiment, if the one or more third input data samples correspond to a class that is already known, the one or more circuits or processors is further configured to provide the third input data samples to an inference module comprising the trained first or further artificial neural network in order to generate a predicted label for controlling the one or more actuators.

According to one embodiment, the system further comprising a controller configured to: detect whether one or more third input data samples correspond to a new distribution not already learnt by the first artificial neural network; and if the one or more third input data samples correspond to the new distribution, to create a new system for learning the one or more third input data samples, the new system comprising at least a further first artificial neural network.

According to one embodiment, the one or more circuits or processors is configured to generate the first pseudo data by: a) injecting a first random sample into the first or second artificial neural network, wherein the first or second artificial neural network is configured to implement at least an auto-associative function ƒ or replicating input samples at one or more of its outputs, the replicated input samples present at the outputs forming the first pseudo data.

According to one embodiment, the one or more circuits or processors is configured to generate the second pseudo data by: a) injecting a second sample into the first or second artificial neural network, wherein the first or second artificial neural network is configured to implement at least an auto-associative function ƒ or replicating input samples at one or more of its outputs, at least some of the replicated input samples present at the outputs forming the second pseudo data, wherein the first sample is a random sample or a real sample.

According to a further aspect, there is provided a method of generating training data for transferring knowledge from a trained artificial neural network to a further artificial neural network, the method comprising: a) injecting a first sample into the trained artificial neural network, wherein the trained artificial neural network is configured to implement at least an auto-associative function for replicating input samples at one or more of its outputs, and wherein the first sample is either a random sample or a real sample; b) reinjecting a pseudo sample, generated based on the replicated sample present at the one or more outputs of the trained artificial neural network, into the trained artificial neural network in order to generate a new replicated sample at the one or more outputs; and c) repeating b) one or more times to generate a plurality of reinjected pseudo samples; wherein the training data for training the further artificial neural network comprises at least two of said reinjected pseudo samples originating from the same first sample and corresponding output values generated by the trained artificial neural network.

According to yet a further aspect, there is provided a system for generating training data for transferring knowledge from a trained artificial neural network to a further artificial neural network, the system comprising a data generator configured to: a) inject a first sample into the trained artificial neural network, wherein the trained artificial neural network is configured to implement at least an auto-associative function ƒ or replicating input samples at one or more of its outputs and wherein the first sample is either a random sample or a real sample; b) reinject a pseudo sample, generated based on the replicated sample present at the one or more outputs of the trained artificial neural network, into the trained artificial neural network in order to generate a new replicated sample at the one or more outputs; and c) repeating b) one or more times to generate a plurality of reinjected pseudo samples; wherein the data generator is further configured to generate the training data for training the further artificial neural network to comprises at least two of said reinjected pseudo samples originating from the same first sample and corresponding output values generated by the trained artificial neural network.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 illustrates a multi-layer perceptron ANN architecture according to an example embodiment;

FIG. 2 shows four graphs representing an example of the catastrophic forgetting problem;

FIG. 3 represents three stages in a method of retaining old memories in an ANN according to an example embodiment of the present disclosure;

FIG. 4 shows four graphs representing training of an ANN according to an example embodiment of the present disclosure;

FIG. 5 is a block diagram representing a computing system implementing the method of FIG. 3 according to an example embodiment of the present disclosure;

FIG. 6 schematically illustrates an ANN architecture according to an example embodiment of the present disclosure;

FIG. 7 schematically illustrates a system for knowledge transfer according to an example embodiment of the present disclosure;

FIG. 8 is a flow diagram illustrating operations in a method of knowledge transfer according to an example embodiment of the present disclosure;

FIG. 9 illustrates a 2-dimensional space providing an example of a model that classifies elements into three classes, and an example of a trajectory of pseudo samples in this space;

FIG. 10 is a graph illustrating examples of random distributions of random samples according to an example embodiment of the present disclosure;

FIG. 11 schematically illustrates a sample generation circuit according to an example embodiment of the present disclosure;

FIG. 12 schematically illustrates a system for retaining old memories in an ANN according to an example embodiment of the present disclosure;

FIG. 13 schematically illustrates a system for retaining old memories in an ANN according to yet a further example embodiment of the present disclosure;

FIG. 14 illustrates a hardware system according to an example embodiment of the present disclosure;

FIG. 15 schematically illustrates an artificial learning system for incremental learning according to a further example embodiment of the present disclosure; and

FIG. 16 schematically illustrates an artificial learning system implementing a plurality of learning models.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, techniques for training an artificial neural network, based for example on minimizing an objective function such as a cost function, are known to those skilled in the art, and will not be described herein in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

While in the following description example embodiments are based on a multi-layer perceptron ANN architecture, it will be apparent to those skilled in the art that the principles can be applied more broadly to any ANN, fully connected or not, such as a deep learning neural network (DNN), convolutional neural network (CNN), or any other type of ANN.

In the following description, the following terms will be assumed to have the following definitions:
“real input data” or “input data samples”: data samples collected and used to train an untrained ANN, this input data being designated as “real” because it is not computer-generated data, and is not therefore synthetic;
“random sample”: a computer-generated synthetic sample based on random or pseudo-random values;
“training data”: any data (real or synthetic) that can be used to train one or more neural networks;
“synthetic data” or “pseudo data”: synthetic data, for example computer generated, that can be used as training data, this data for example comprising at least pseudo samples, and in the case of training a classier, pseudo labels associated with the pseudo samples;
“pseudo sample”: a computer-generated synthetic sample generated based on a guided data generation process or using preprocessing;
“pseudo label”: a label generated by a trained neural network in response to the injection of a pseudo sample, wherein the pseudo label corresponds to the ground truth to be targeted during the training of an ANN using training data; and
“auto-associative”: the function of replicating inputs, like in an auto-encoder. However, the term “auto-encoder” is often associated with an ANN that is to perform some compression, for example involving a compression of the latent space meaning that the one or more hidden layers contain less neurons than the number of neurons of the input space. In other words, the input space is embedded into a smaller space. The term “auto-associative” is used herein to designate a replication function similar to that of an auto-encoder, but an auto-associative function is more general in that it may or may not involve compression.

FIG. 1 illustrates a multi-layer perceptron ANN architecture 100 according to an example embodiment.

The ANN architecture 100 according to the example of FIG. 1 comprises three layers, in particular an input layer (INPUT LAYER), a hidden layer (HIDDEN LAYER), and an output layer (OUTPUT LAYER). In alternative embodiments, there could be more than one hidden layer. Each layer for example comprises a number of neurons. For example, the ANN architecture 100 defines a model in a 2-dimensional space, and there are thus two visible neurons in the input layer receiving the corresponding values X1 and X2 of an input X. The model has a hidden layer with seven output hidden neurons, and thus corresponds to a matrix of dimensions R^{2*7}. The ANN architecture 100 of FIG. 1 corresponds to a classifying network, and the number of neurons in the output layer thus corresponds to the number of classes, the example of FIG. 1 having three classes.

The mapping y=ƒ(x) applied by the ANN architecture 100 is a functions aggregation, comprising an associative function gₙ within each layer, these functions being connected in a chain to map y=ƒ(x)=g₁(g₂( . . . (gₙ(x)) . . . )). There are just two such functions in the simple example of FIG. 1, corresponding to those of the hidden layer and the output layer.

Each neuron of the hidden layer receives the signal from each input neuron, a corresponding parameter θⱼⁱ being applied to each neuron j of the hidden layer from each input neuron i of the input layer. FIG. 1 illustrates the parameters θ₁¹ to θ₇¹ applied to the outputs of a first of the input neurons to each of the seven hidden neurons.

The goal of the neural model defined by the architecture 100 is to approximate some function F:X→Y by adjusting a set of parameters θ. The model corresponds to a mapping yₚ=ƒ(x;θ), the parameters θ for example being modified during training based on an objective function, such as a cost function. For example, the objective function is based on the difference between ground truth yₜ and output value yₚ. In some embodiments, the mapping function is based on a non-linear projection φ, generally called the activation function, such that the mapping function ƒ can be defined as yₚ=ƒ(x;θ,w)=φ(x;θ)^{T}w, where θ are the parameters of φ, and w is a vector value. In general, a same function is used for all layers, but it is also possible to use a different function per layer. In some cases, a linear activation function φ could also be used, the choice between a linear and non-linear function depending on the particular model and on the training data.

The vector value w is for example valued by the non-linear function φ as the aggregation example. For example, the vector value w is formed of weights W, and each neuron k of the output layer receives the outputs from each neuron j of the hidden layer weighted by a corresponding one of the weights Wⱼ^{k}. The vector value can for example be viewed as another hidden layer with a non-linear activation function φ and its parameters W. FIG. 1 represents the weights W₁¹ to W₁³ applied between the output of a top neuron of the hidden layer and each of the three neurons of the output layer.

The non-linear projection φ is for example manually selected, for example as a sigmoid function. The parameters θ of the activation function are, however, learnt by training, for example based on the gradient descent rule. Other features of the ANN architecture, such as the depth of the model, the choice of optimizer for the gradient descent and the cost function, are also for example selected manually.

There are two procedures that can be applied to an ANN such as the ANN 100 of FIG. 1, one being a training or backward propagation procedure in order to learn the parameters θ, and the other being an inference or feedforward propagation procedure, during which input values X flow through the function, and are multiplied by the intermediate computations defining the mapping function ƒ, in order to generate an output y.

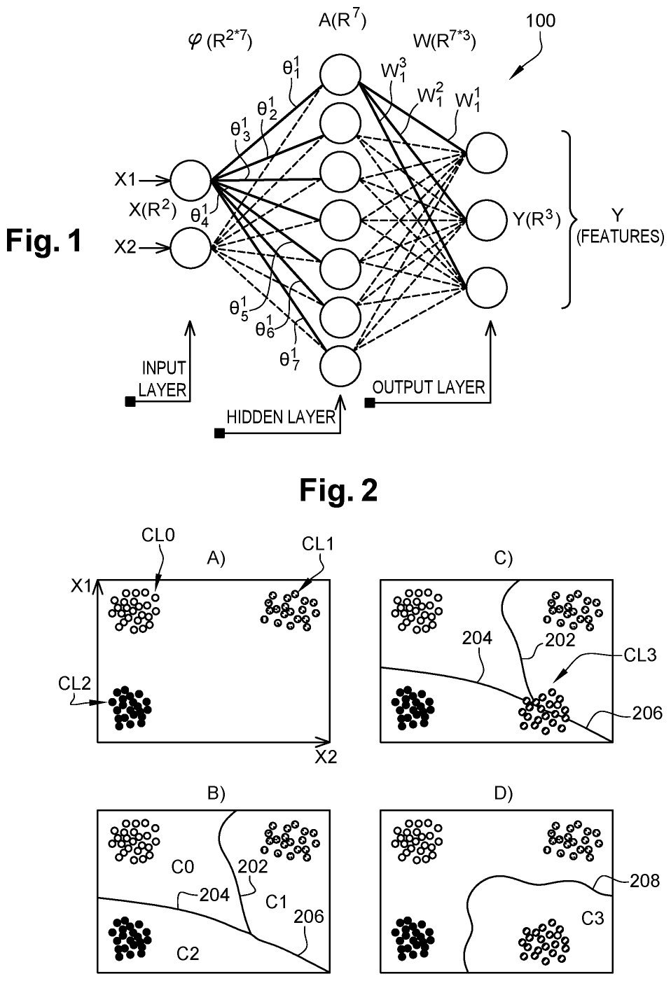

As explained in the background section above, in some embodiments, an ANN such as the ANN 100 of FIG. 1 can struggle in realistic scenarios when the distribution of training data only becomes available over the course of training. Indeed, it is generally desired that an ANN is capable of easily adapting to learn new information, but a drawback of this plasticity is that it is often difficult to build upon a trained model while conserving a previous mapping function. The problem of catastrophic forgetting will now be described in more detail with reference to FIG. 2.

FIG. 2 shows four graphs A), B), C) and D) representing an example of the catastrophic forgetting problem. The example of FIG. 2 is based on an ANN, such as the ANN 100 of FIG. 1, learning four classes in two steps.

The graph A) of FIG. 2 illustrates an example of a 2-dimensional space containing three clusters CL0, CL1 and CL2 of training samples each having a pair of values X1 and X2, which will be referred to herein as features, and that are to be used to train the ANN. The three clusters CL0, CL1 and CL2 respectively correspond to samples falling into three classes C0, C1 and C2, and the ANN is to be trained to learn these three classes in parallel.

The graph B) of FIG. 2 illustrates the same 2-dimensional space as the graph A) after a first step of training of the three classes C0, C1 and C2 based on the clusters CL0, CL1 and CL2 of training samples. In particular, the graph B) illustrates an example of class boundaries 202, 204 and 206 that have been learnt by the ANN, the boundary 202 separating the classes C0 and C1, the boundary 204 separating the classes C0 and C2, and the boundary 206 separating the classes C1 and C2.

The graph C) of FIG. 2 illustrates the same 2-dimensional space and class boundaries as the graph B), and additionally illustrates a further cluster CL3 of training samples to be learnt by the ANN during a second step of training, these training samples falling within a fourth class C3.

The graph D) of FIG. 2 illustrates the 2-dimensional space after learning the new class C3 during the second training step. As illustrated, a new boundary 208 has been learn that separates the class C3 from the other three classes, but the previously learnt class boundaries between the classes C0, C1 and C2 have been lost. Thus, the ANN is no longer able to separate the classes C0, C1 and C2.

A solution to avoiding catastrophic forgetting, based on reverberating neural networks, is described in the publication by B. Ans and S. Rousset entitled “Avoiding catastrophic forgetting by coupling two reverberating neural networks”, C. R. Acad. Sci. Paris. Sciences de la vie/Life Sciences 1997. 320, 989-997.

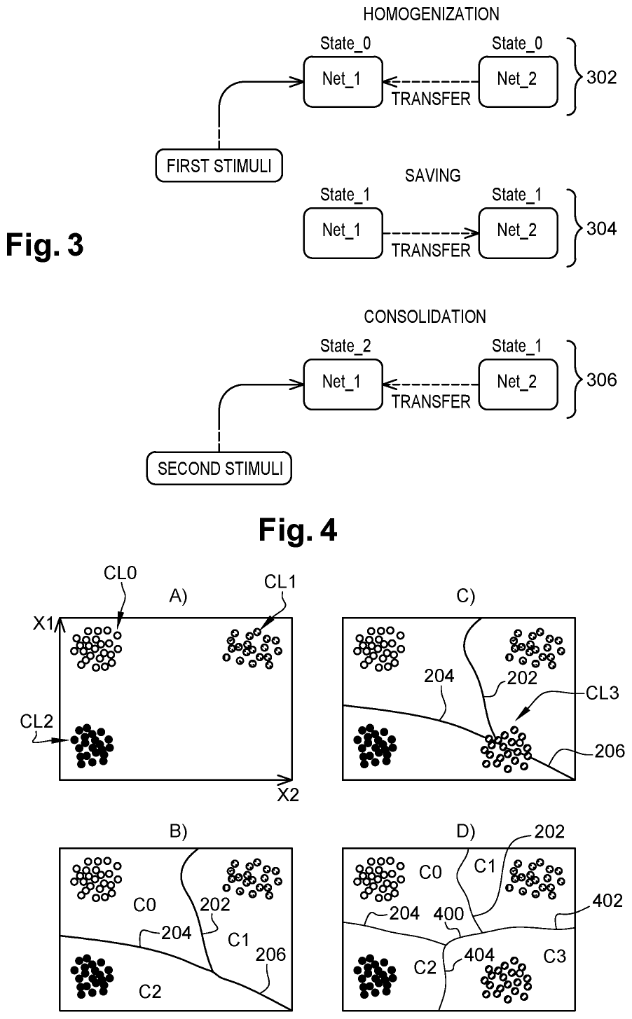

FIG. 3 represents three stages in a method of retaining old memories in an ANN according to an example embodiment of the present disclosure. The method for example involves the use of two ANNs labelled Net_1 and Net_2. Each of these ANNs for example corresponds to an ANN like the one of FIG. 1 above. In some embodiments, Net_1 and Net_2 have, as a minimum level of similarity, the same numbers of neurons in their input layers and the same numbers of neurons in their output layers. In some embodiments, these ANNs also have the same number of hidden layers and of neurons as each other.

Initially, the ANNs Net_1 and Net_2 have identical, or relatively similar initial states, called State_0 in FIG. 3. The “state” of an ANN corresponds to the particular values of the parameters θ and weights W stored by the ANN.

In some embodiments, for example in the case that Net_1 and Net_2 have the same architecture, the state from one of the ANNs is initialized in a random state, such an initial state being referred to herein as a “virgin” state. For example, such a virgin state implies that all of the parameters θ and weights W of the ANN have been set to random values. This state is then copied to the other ANN, for example by copying each of the parameters θ and weights W.

Alternatively, for example if the architectures of Net_1 and Net_2 are different, the initial state of one of the ANNs is for example learnt by the other. For example, the ANN Net_2 is initialized in a random virgin state, and then this state is transferred to the ANN Net_1 during a pre-homogenization operation (not shown in FIG. 3). Such transfer learning will be described in more detail below.

In a first stage (HOMOGENIZATION) 302 of the method of FIG. 3, Net_1 is configured to learn first new stimuli (FIRST STIMULI), as well as learning the virgin state State_0 from Net_2 as represented by an arrow (TRANSFER) from Net_2 to Net_1. The first new stimuli for example includes one or more initial classes to be learnt by Net_1. Net_2 is for example configured to generate pseudo data that describes its initialization (virgin) state. In some embodiments, a real sample, or a sample consisting of Gaussian noise, is applied to Net_2, and one or more re-injections are performed, in order to generate the pseudo data based on trajectories of pseudo samples, as will be described in more detail below. Classic deep learning tools are for example used to allow the new data, and the pseudo data from Net_2, to be learnt by Net_1 during this stage.

At the end of the first stage 302, the state of Net_1 has been modified from the initial state State_0 to a new state State_1.

In a second stage (SAVING) 304, the state State_1 of Net_1 is for example transferred to, and stored in Net_2, as represented by an arrow (TRANSFER) from Net_1 to Net_2. In the case that Net_1 and Net_2 have the same depth and width as each other, the parameters and weights are for example simply copied from Net_1 to Net_2 in order to perform this transfer. Otherwise, other known techniques for knowledge transfer could be employed, or the technique described below with reference to FIGS. 6 to 11, and in the co-pending French application no. FR2003326 filed on 2 Apr. 2020, could also be employed.

Thus, after the second stage 304, Net_2 is for example capable of yielding similar performance to Net_1 in terms of input replication and classification. Net_2 is thus capable of generating old memories that were previously held by Net_1 during subsequent training of Net_1.

In a third stage (CONSOLIDATION) 306, second new stimuli (SECOND STIMULI) is applied to Net_1, and Net_1 is configured to learn this second new stimuli as well as relearning the state State_1 stored by Net_2, as represented by an arrow (TRANSFER) from Net_2 to Net_1. The second new stimuli for example includes one or more additional classes to be learnt by Net_1. Net_2 is for example configured to generate pseudo data that describes the stored state State_1. In some embodiments, Gaussian noise is applied to Net_2, and one or more re-injections are performed, in order to generate the pseudo data, as will be described in more detail below. Classic deep learning tools are for example used to allow the new data, and the pseudo data from ANN Net_2, to be learnt by Net_1 during this stage.

The training of Net_1 during the stages 302 and 306 is for example performed based on a certain ratio between the new stimuli data and the pseudo data. For example, at least one pseudo data sample is applied to Net_1 for each new stimuli data sample that is applied, although the pseudo data samples and new stimuli samples may be grouped. For example, there could be up to 1000 new stimuli samples, followed by up to 1000 or more pseudo data samples.

However, the influence on Net_1 of the new stimuli data samples is likely to be greater than the influence of the pseudo data samples, and therefore, in some embodiments there may be a greater proportion of pseudo samples than new stimuli samples. For example, in some embodiments, the ratio R of new stimuli data samples to pseudo data samples is at least 1 to 10, and for example at least 1 to 20.

An advantage of training, during the third stage 306, Net_1 with both new stimuli and pseudo data generated by Net_2 is that old memories can be learnt at the same time as the new stimuli. Indeed, pseudo data doses from Net_2 will cause Net_1 to drift along the parameter space by looking for a solution that satisfies both the conditions of the new stimuli and the conditions of the pseudo data. Thus, Net_1 will be trained to fit both the old memories and the new information into its model. This means, for example, that, unlike in the example of FIG. 2D, class boundaries that were learnt during the stage 302 (such as the class boundaries 202, 204, 206 of FIGS. 2B and 2C) will not be lost, but will be maintained by the pseudo samples of Net_2.

FIG. 4 shows four graphs representing training of an ANN based on the method of FIG. 3. The example is the same as that of FIG. 2. However, the learning of the boundaries 202, 204 and 206 of graph B between the classes C0, C1 and C2 occurs during the homogenization stage, and thus, while the boundaries are similar to those of FIG. 2, they are learnt alongside the state State_0 from the ANN Net_2. Furthermore, as represented by graph D of FIG. 4, during the learning of the new class corresponding to the cluster of samples CL3, the state State_1 of Net_2, which contains the previously learnt boundaries 202, 204, 206, continues to be used to generate pseudo samples. The result is that the boundaries 202 and 204 are partially maintained while new boundaries 400, 402 and 404 are learnt between the class C3 and the classes C0, C1 and C2 respectively.

With reference again to FIG. 3, while, in the stage 304, the knowledge held by Net_1 is at least partially transferred to Net_2, it would also be possible to instead at least partially transfer this knowledge to another ANN different from Net_2, and to use this other ANN to generate the pseudo data samples. However, an advantage of using the same ANN for both generating pseudo data samples during the homogenization stage 302, and generating pseudo data samples corresponding to old memories during the consolidation stage 306, is that fewer ANNs are required than if different ANNs were used.

Each of the ANNs Net_1 and Net_2 of FIG. 3 may be implemented by a dedicated hardware circuit, and a hardware interface could be provided in order to implement the transfers between the ANNs. In such a case, during the homogenization and consolidation phases, it is possible to perform, at least partially in parallel, the generation of pseudo data by the neural network Net_2, and the learning of the new stimuli and the pseudo data by the neural network Net_1.

Alternatively, only the first artificial neural network Net_1 is present, and a buffer, for example implemented by a volatile or non-volatile memory, is used to store the generated pseudo samples in advance. For example, Net_1 is initially in the virgin state, and is used to generate pseudo data samples, which are stored to the buffer. Net_1 is then trained using the first stimuli and the pseudo data samples from the buffer. In such a case, the saving operation can be omitted, but prior to the consolidation phase, Net_1 is again used to generate new pseudo samples, which are again stored to the buffer. Net_1 is then trained using the second stimuli and the new pseudo data samples from the buffer.

Alternatively still, the first and second artificial neural networks are implemented by a same neural network circuit. Indeed, in the case of a single ANN Net_1 as described in the previous paragraph, the virgin state, and each subsequent state reached by Net_1 prior to a training phase, is lost during the subsequent training phase, and therefore it is no longer possible to generate more pseudo samples later. Generating more pseudo samples would however be possible if the state of the ANN is also stored before each new training phase, such that at least the state t-1 can be reloaded. For example, the buffer is further used to store sets of configuration data associated with the neural networks so that the same neural network circuit can perform, in series, the roles of both of the neural networks Net_1 and Net_2. The configuration data for example includes the parameters, weights and activation functions of the neural network. For example, the neural network circuit is configured to perform the role of the neural network Net_1 by loading, from the buffer to the neural network circuit, a first set of configuration data associated with the neural network Net_1. Before this loading, if the neural network circuit has been performing the role of Net_2, the set of configuration data associated with Net_2 may first be stored from the neural network circuit to the buffer. The neural network circuit is for example configured to perform the role of the neural network Net_2 by loading, from the buffer to the neural network circuit, a second set of configuration data associated with the neural network Net_2. Before this loading, if the neural network circuit has been performing the role of Net_1, the set of configuration data associated with Net_1 may first be stored from the neural network circuit to the buffer. Thus, the pseudo data to be used during the homogenization phase 302 is for example generated first by Net_2, and stored to memory, and is then subsequently used during the training of Net_1 in addition to the first stimuli. Similarly, the pseudo data to be used during the consolidation phase 306 is for example generated first by Net_2, and stored to memory, and is then subsequently used during the training of Net_1 in addition to the second stimuli.

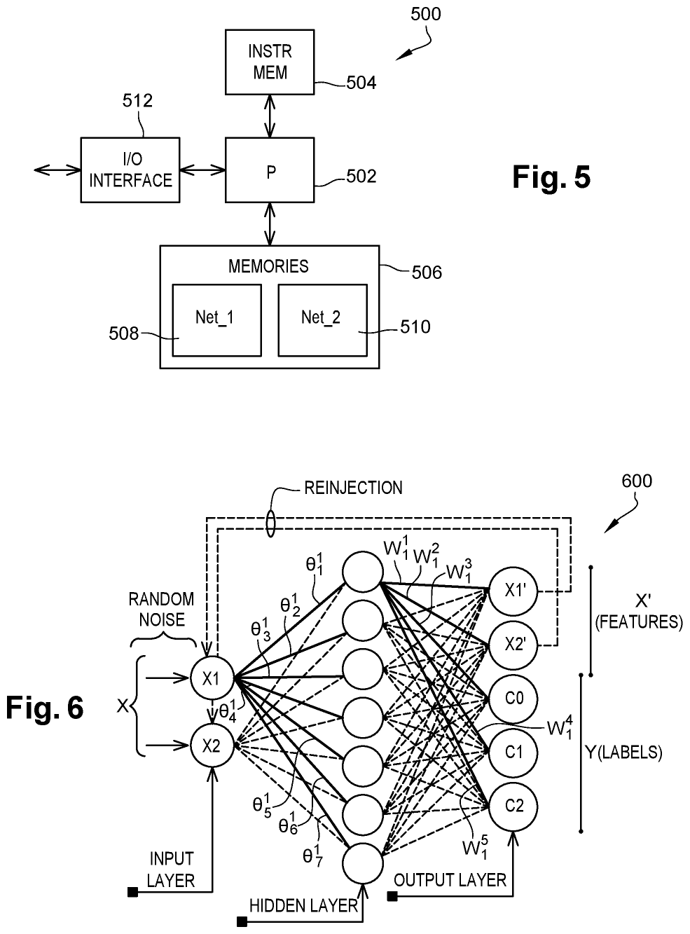

Alternatively, Net_1 and Net_2 could be emulated by software executed within a computing system, as will now be described in more detail with reference to FIG. 5.

FIG. 5 is a block diagram representing a computing system 500 configured to implement the method of FIG. 3. For example, the computing system 500 comprises a processing device (P) 502 comprising one or more CPUs (Central Processing Units) under control of instructions stored in an instruction memory (INSTR MEM) 504. Alternatively, rather than CPUs, the computing system could comprise one or more NPUs (Neural Processing Units), or GPUs (Graphics Processing Units), under control of the instructions stored in the instruction memory 504. A further memory (MEMORY) 506, which may be implemented in a same memory device as the memory 504, or in a separate memory device, for example stores the ANNs Net_1 and Net_2 in respective memory locations 508, 510, such that a computer emulation of these ANNs is possible. For example, the ANNs are fully defined in the memory 506, including their input and output layers and hidden layers, their parameters and weights, and the activation functions applied by their neuron circuits. In this way, the ANNs Net_1 and Net_2 can be trained and operated within the computing environment of the computing system 500.

In some embodiments, the computing system 500 also comprises an input/output interface (I/O INTERFACE) 512 via which new stimuli is for example received, and from which results data can be output from the ANNs.

An example of a technique for knowledge transfer from one ANN to another will now be described with reference to FIGS. 6 to 11.

FIG. 6 schematically illustrates an ANN architecture 600 according to an example embodiment, this architecture for example being used to implement at least Net_2 of FIG. 3, and in some cases also Net_1.

The ANN 600 of FIG. 6 is similar to the ANN 100 of FIG. 1, but additionally comprises an auto-associative portion capable of replicating the input data using neurons of the output layer. Thus, this model performs an embedding from [symbol] ⁿ→ [symbol] ⁿ×{1, 2, . . . c}, +) with n the features, and c the classes. Like in the example of FIG. 1, in the ANN 600 of FIG. 6, each input sample has two values, corresponding to a 2-dimensional input space, and there are thus also two corresponding additional output neurons (FEATURES) for generating an output pseudo sample (X′) replicating the input sample. For example, each input sample X is formed by a pair of values X1, X2, and the ANN 600 classifies these samples as being either in a class C0, C1 or C2, corresponding to the label (LABELS) forming the output value Y.

The auto-associative portion of the ANN 600 behaves in a similar manner to an auto-encoder. Auto-encoders are a type of ANN known to those skilled in the art that, rather than being trained to perform classification, are trained to replicate their inputs at their outputs. As indicated above, the term “auto-associative” is used herein to designate a functionality similar to that of an auto-encoder, except that the latent space is not necessarily compressed. Furthermore, like for the training of an auto-encoder, the training of the auto-associative part of the ANN may be performed with certain constraints in order to avoid the ANN converging rapidly towards the identity function, as well known by those skilled in the art.

The ANN 600 is for example implemented by dedicated hardware, such as by an ASIC (application specific integrated circuit), or by a software emulation executed on a computing system as described above in relation with FIG. 5, or by a combination of dedicated hardware and software.

In the example of FIG. 6, the network is common for the auto-associative portion and the classifying portion, except in the output layer. Furthermore, there is a connection from each neuron of the hidden layer to each of the neurons X1′ and X2′ of the output layer. However, in alternative embodiments, there could be a lower amount of overlap, or no overlap at all, between the auto-associative and classifying portions of the ANN 600. Indeed, in some embodiments, the auto-associative and hetero-associative functions could be implemented by separate neural networks. In some embodiments, in addition to the common neurons in the input layer, there is at least one other common neuron in the hidden layers between the auto-associative and classifying portions of the ANN 600. A common neuron implies that this neuron supplies its output directly, or indirectly, i.e. via one or more neurons of other layers, to at least one of the output neurons of the auto-associative portion and at least one of the output neurons of the classifying portion.

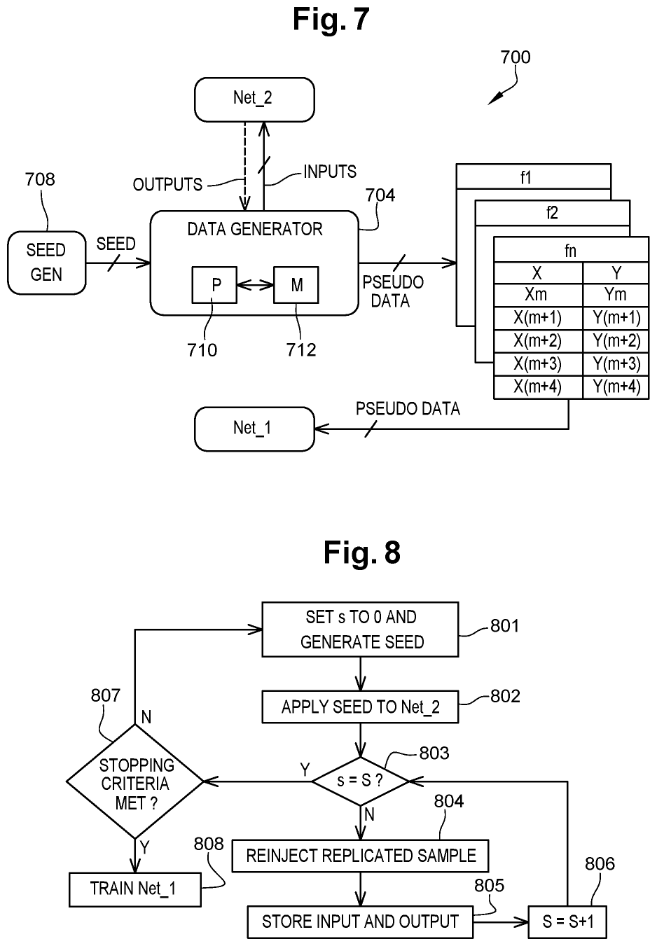

As illustrated in FIG. 6, a reinjection (REINJECTION) is performed of the auto-associative outputs back to the inputs of the ANN. Such a reinjection is performed in order to generate synthetic training data, i.e. pseudo data, and as will be described in more detail below, the reinjection is for example performed by a data generator (described in relation with FIG. 7 below) that is coupled to the ANN. Thus, the auto-associative portion of the ANN model is used as a recursive function, in that its outputs are used as its inputs. This results in a trajectory of the outputs, wherein, after each reinjection, the generated samples become closer to the real raw samples in interesting areas of the transfer function to be learnt. Advantageously, according to the embodiments described herein, for each seed injected into the ANN, at least two points on this trajectory are for example used to form pseudo data for training another ANN.

The generation of training data for knowledge transfer based on the ANN 600 will now be described in more detail with reference to FIGS. 7 to 9.

FIG. 7 schematically illustrates a system 700 for knowledge transfer according to an example embodiment of the present disclosure.

The system 700 comprises the ANNs Net_1 and Net_2. Net_2 is for example implemented in a similar manner to the ANN of FIG. 6, and comprises, in particular, at least an auto-associative portion. Net_1 to be trained may correspond to a classic architecture that is configured to only perform classification, e.g. of the type described in relation with FIG. 1 above. Alternatively, Net_1 could have auto-associative or auto-encoding portions in addition to the classification function, this ANN for example being of the type represented in FIG. 6.

The system 700 also comprises a data generator (DATA GENERATOR) 704 configured to make use of the auto-associative function of Net_2 in order to generate pseudo data (PSEUDO DATA) for training Net_1.

The data generator 704 for example receives a seed value (SEED) generated by a seed generator (SEED GEN) 708. The seed generator 708 is for example implemented by a pseudo-random generator or the like, and generates values based on a given random distribution, as will be described in more detail below.

Alternatively, the seed generator 708 could generate the seed values based on real data samples, at least in the case of the generation of pseudo-data during the consolidation phase 306 of FIG. 3. For example, the seed generator 708 comprises a memory storing a limited number of real data samples, which are selected, for example randomly, from the real data set, or correspond to samples received during a limited time period. This memory can therefore be relatively small. Each seed value is for example drawn, in some cases by a random selection, from among these real data samples, with or without the addition of noise. For example, in the case that noise is added, the amount of noise is chosen such that the noise portion represents between 1% and 30% of magnitude of the seed value, and in some cases between 5% and 20% of magnitude of the seed value. Such a technique is for example applicable in any method of generating training data for transferring knowledge from a trained artificial neural network to a further artificial neural network, and is not limited to being used during the method of generating old memories as described herein.

The data generator 704 for example generates input values (INPUTS) provided to Net_2, receives output values (OUTPUTS) from Net_2, and generates pseudo data (PSEUDO DATA) comprising the pseudo samples and resulting pseudo labels, as will be described in more detail below. The pseudo data is for example used on the fly to train Net_1, or it is stored to one or more files, which are for example stored by a memory, such as a non-transitory memory device. For example, the pseudo data is stored to a single file.

In some embodiments, the functionalities of the data generator 704 are implemented by a processing device (P) 710, which for example executes software instructions stored by a memory (M) 712. Alternatively, the data generator 704 could be implemented by dedicated hardware, such as by an ASIC.

FIG. 8 is a flow diagram illustrating operations in a method of knowledge transfer according to an example embodiment of the present disclosure. This method is for example implemented by the system 700 of FIG. 7.

In an operation 801, a variable s is initialized, for example at 0, and a first seed value is generated by the seed generator 708.

In an operation 802, the first seed value is for example applied by the data generator 704 as an input to Net_2. Thus, Net_2 propagates the seed X0 through its layers and generates, at its output layer, labels Y0 corresponding to the classification of the seed, and features X0′ corresponding to the seed modified based on the trained auto-associative portion of the ANN.

For the purpose of classification, it is generally desired that the generated pseudo labels of an ANN are formatted, for example using one hot encoding, to indicate the determined class. However, in reality, the ANN will generate unnormalized outputs that represent the relative probability of the input sample falling within each class, in other words the relative probability to assign a probability of all the classes, instead of a discrete class. Advantageously, the pseudo data comprises pseudo labels in the form of the unnormalized output data, thereby providing greater information for the training of Net_2, and in particular including the information that is delivered for all of the classes, and not just the class that is selected. For example, logits or distillation can be used to train a model using pseudo labels, as known by those skilled in the art. This for example uses binary cross-entropy. Distillation is for example described in more detail in the publication by Geoffrey Hinton et al. entitled “Distilling the Knowledge in a Neural Network” (arXiv.1503.02531v1, 9 Mar. 2015), and in the US patent application published as US2015/0356461. For the case of synthetic samples that may not belong sharply to a particular class, a logit/distillation method is for example used, as known by those skilled in the art, this method for example being used to assign probability of all classes instead of a discrete class. The relative probabilities indicate how a model tends to generalize and helps to transfer the generalization ability of a trained model to a new model. Rather than distillation, other optimization methods can additionally or alternatively be used in order to improve the efficiency of incremental learning, for example classification task, or any other computational tasks addressed by neural networks.

In an operation 803, it is then determined whether the variable s has reached a value S, which is for example a stopping condition for the number of reinjections based on each seed. In one example, the value S is equal to 6, but more generally it could be equal to between 2 and 20, and for example between 4 and 10, depending on the size of the input space, and depending on the quality of the trained auto-association. Indeed, when the auto-association is well trained, in other words such that there is a relatively low error between inputs in the replications of the network, relatively few reinjections, e.g. less than 10, can for example be used to provide a good sampling of the input space. Otherwise, a relatively high number of reinjections, for example between 10 and 20, may be used in order to find the regions of interest.

In alternative embodiments, rather than the stopping condition in operation 803 being a fixed number of reinjections, it could instead be based on the variation between the replications, such as based on a measure of the Euclidean distance, or any other type of distance, between the last two projections. For example, if the Euclidean distance has fallen below a given threshold, the stopping condition is met. Indeed, the closer the replications become to each other, the closer the pseudo samples are becoming to the underlying true sample distribution.

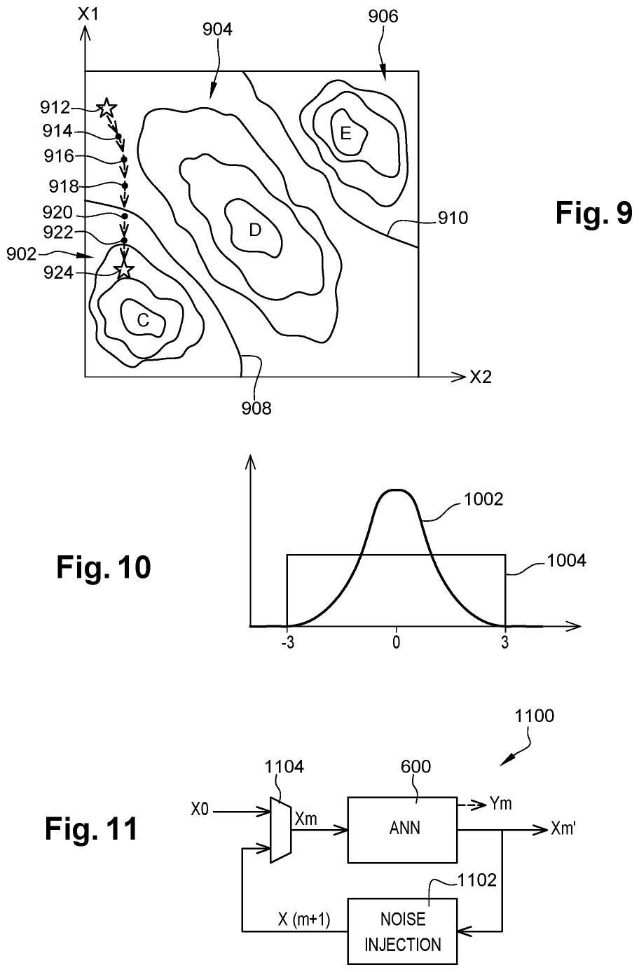

Initially the variable s is set to 0, and thus is not equal to S. Therefore, the next operation is an operation 804, in which the pseudo sample at the output of Net_2 is reinjected into Net_2. Then, in an operation 805, the pseudo sample reinjected into Net_2 in operation 804, and the corresponding output pseudo label from Net_2, are for example stored to form pseudo data, as will now be described in more detail with reference to FIG. 9.

FIG. 9 represents an example based on a classification function. However, the techniques described apply equally to any type of learning function.

FIG. 9 illustrates in particular a 2-dimensional space providing an example of a model that classifies elements into three classes C, D and E, where input samples are defined as points represented by pairs of input features X1 and X2. FIG. 9 also illustrates an example of pseudo samples in this space that follow a pseudo sample trajectory from a random seed through to a final pseudo sample.

As an example, X∈ [symbol] ², where X1 is a weight feature, X2 is a corresponding height feature, and the function yₚ=ƒ(X;θ) maps the height and weight samples into a classification of cat (C), dog (D) or elephant (E). In other words, the ANN is trained to define a non-linear boundary between cats, dogs and elephants based on a weight feature and a height feature of an animal, each sample described by these features falling in one of the three classes.

The space defined by the value X1 in the y-axis and X2 in the x-axis is divided into three regions 902, 904 and 906 corresponding respectively to the classes C, D and E. In the region 902, any sample has a higher probability of falling in the class C than in either of the other classes D and E, and similarly for the regions 904 and 906. A boundary 908 between the C and D classes, and a boundary 910 between the D and E classes, represent the uncertainty of the model, that is to say that, along these boundaries, samples have equal probabilities of belonging to each of the two classes separated by the boundary. Contours in FIG. 9 represent the sample distributions within the area associated with each class, the central zones labelled C, D and E corresponding to the highest density of samples. An outer contour in each region 902, 904, 906 indicates the limit of the samples, the region outside the outer contour in each region 902, 904, 906 for example corresponding to out-of-set samples.

An example of the seed is shown by a star 912 in FIG. 9, and a trajectory of pseudo samples 914, 916, 918, 920, 922 and 924 generated starting from this seed are also shown. Each of these pseudo samples for example results from a reinjection of the previous pseudo sample. After a certain number of reinjections, equal to six reinjections in the example of FIG. 9, reinjecting is for example stopped with a final pseudo sample represented by a star 924 in FIG. 9. As represented by the operation 805 of FIG. 8, input and output values corresponding to each point on the trajectory are for example stored to form the pseudo data. Alternatively, only a subset of the points is used to form the pseudo data. For example, at least two points on the trajectory are used.

With reference again to FIG. 8, in an operation 806, the variable s is then incremented, and then the method returns to operation 803. This loop is repeated until, in operation 803, the variable s is equal to the limit S. Then, the next operation is an operation 807.

In the operation 807, it is determined whether a further stopping criteria has been met. For example, this further stopping criteria could be based on whether an overall number of pseudo samples have been generated, the method for example ending when the number of pseudo samples is considered high enough to enable the training of Net_1. This may depend for example on the accuracy of the trained model.

If, in operation 807, the stopping criteria has not been met, the method returns to the operation 801, such that a new seed is generated, and a new set of pseudo samples is generated for this new seed.

When, in operation 807, the stopping criteria has been met, in an operation 808, Net_1 is for example trained based on the generated training data. Indeed, the gathered pseudo data contains a partial representation of the internal function ƒ (mapping function) of the model, and is for example stored as a single file that characterizes the trained model. Net_1 is then able to learn the captured function of the model using the training data of the pseudo dataset using known deep learning tools that are well known to those skilled in the art.

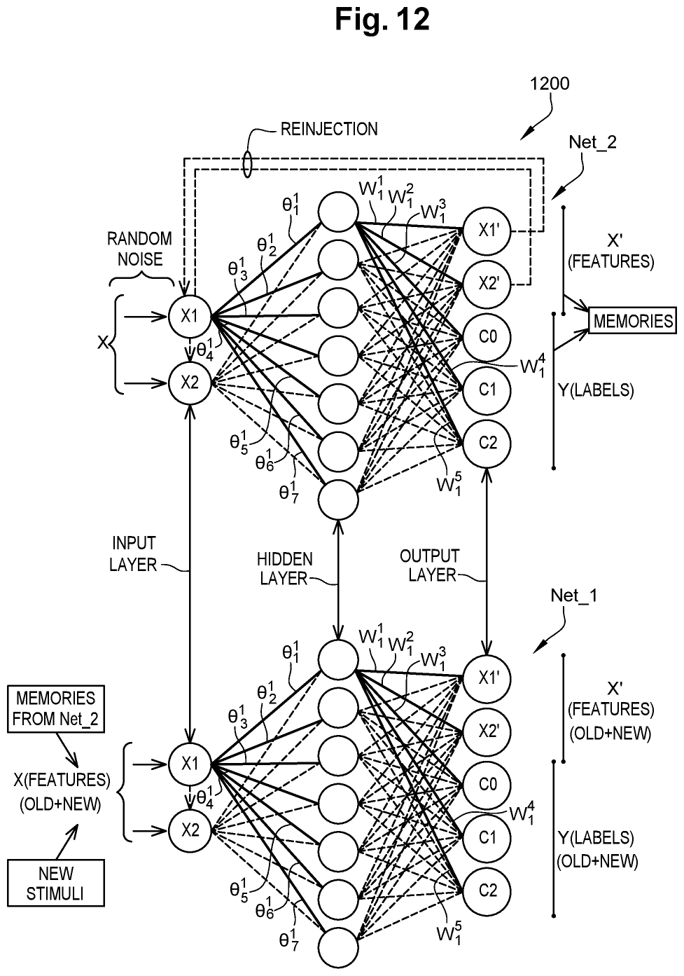

Alternatively, rather than generating a file containing all of the generated training data, training of Net_1 could be performed on the fly during the pseudo data generation as will be described in more detail below with reference to FIG. 12.

It will be noted that, in the example of FIG. 8, the first pseudo sample to be stored is for example the one resulting from the first reinjection. Thus, the seed itself is not used as the input value of a pseudo sample. Indeed, a finite number of raw random samples are not considered to efficiently characterize the function ƒ that is to be transferred.

Furthermore, as indicated above, it is also possible to select only some of the points on the trajectory of the pseudo samples to form part of the training data. For example, in some embodiments, points are selected that lie close to a class boundary. For example, with reference to FIG. 9, in the case of the trajectory from 912 to 924, at least the points 918 and 920 are for example chosen to form part of the training data, as these points are particularly relevant to the definition of the boundary 908. The operation 805 of FIG. 8 may therefore involve detecting whether the pseudo label generated by the reinjected sample in operation 804 is different from the pseudo label generated by the immediately preceding reinjected sample, and if so, these two consecutive pseudo samples are for example selected to form part of the training data.

FIG. 10 is a graph illustrating examples of random distributions of random samples generated by the seed generator 708 of FIG. 7 according to an example embodiment of the present disclosure.

A curve 1002 represents one example in which the distribution is a Gaussian distribution that has the shape X˜ [symbol] (μ=0, σ²=1), although more generally any normal distribution could be used.

A curve 1004 represents another example in which the distribution is a tuned uniform distribution that has the shape X˜U(−3,3), although more generally a tuned uniform distribution with a shape X˜U(−A,A) could be used, for A≥1.

Whatever the chosen random distribution, the same distribution is for example used to independently generate all of the seeds that will be used as the starting point for the trajectories of pseudo samples. As many random values as neurons in the input layer are for example sampled from the selection distribution in order to generate each input vector. This input vector is thus the same length as the model input layer, and belongs to the input space of the true samples.

However, as discussed above, rather than using a random seed, it would also be possible to selection a real sample for use as the seed, with or without the addition of noise.

During the generation of pseudo samples at the stage 302, 304 and/or 306 of FIG. 3, rather than reinjecting the auto-associative output values of the ANN as the subsequent input sample of the ANN, it is also possible to first modify the output values, as will now be described in more detail with reference to FIG. 11.

FIG. 11 schematically illustrates a sample generation circuit 1100 according to an example embodiment of the present disclosure. This circuit 1100 is for example partly implemented by the data generator 704 of FIG. 7, and partly by the ANN 600 forming the ANN Net_2 of FIG. 7.

The data generator 704 feeds input samples Xm to the ANN 600. The classifying portion of the ANN 600 thus generates corresponding pseudo labels Ym, and the auto-associative portion thus generates corresponding pseudo samples Xm′. The pseudo samples Xm′ are provided to a noise injection module (NOISE INJECTION) 1102, which for example adds a certain degree of random noise to the pseudo sample in order to generate the next pseudo sample X(m+1) to be fed to the ANN 600. For example, in some embodiments, the random noise is selected from a Gaussian distribution, such as from Gaussian [symbol] (0,I), and is for example pondered by a coefficient Z. For example, the coefficient Z is chosen such that, after injection, the noise portion represents between 1% and 30% of magnitude of the pseudo sample, and in some cases between 5% and 20% of magnitude of the pseudo sample.

For example, a multiplexer 1104 receives at one of its inputs an initial random sample X0, and at the other of its inputs the pseudo samples X(m+1). The multiplexer for example selects the initial sample on a first iteration corresponding to operation 802 of FIG. 8, and selects the sample X(m+1) on subsequent iterations, corresponding to the operations 804 of FIG. 8, until the number S of reinjections has occurred.

FIG. 12 schematically illustrates a system 1200 for retaining old memories in an ANN according to an example embodiment of the present disclosure. In particular, FIG. 12 represents a system for implementing the training stages 302 and 306 of FIG. 3 on the fly, wherein Net_2 is implemented by an ANN similar to the ANN 600 of FIG. 6, and Net_1 is also implemented by an ANN similar to that of FIG. 6, but without the reinjection path.

In the example of FIG. 12, the generation of pseudo data (MEMORIES) by Net_2, and the training of Net_1 based on this pseudo data (MEMORIES FROM Net_2) and based on the new stimuli (NEW STIMULI), for example occurs at least partially in parallel.

During the stage 304 of FIG. 3, the transfer from Net_1 to Net_2 could for example be performed using the same approach as represented in FIG. 12, but in which Net_1 and Net_2 are inversed, and it is Net_1 that performs reinjection. Alternatively, it would also be possible for this transfer to be implemented in other ways, for example by simply copying the learned parameters and weights from Net_1 to Net_2 on ANNs that have the same parameters.

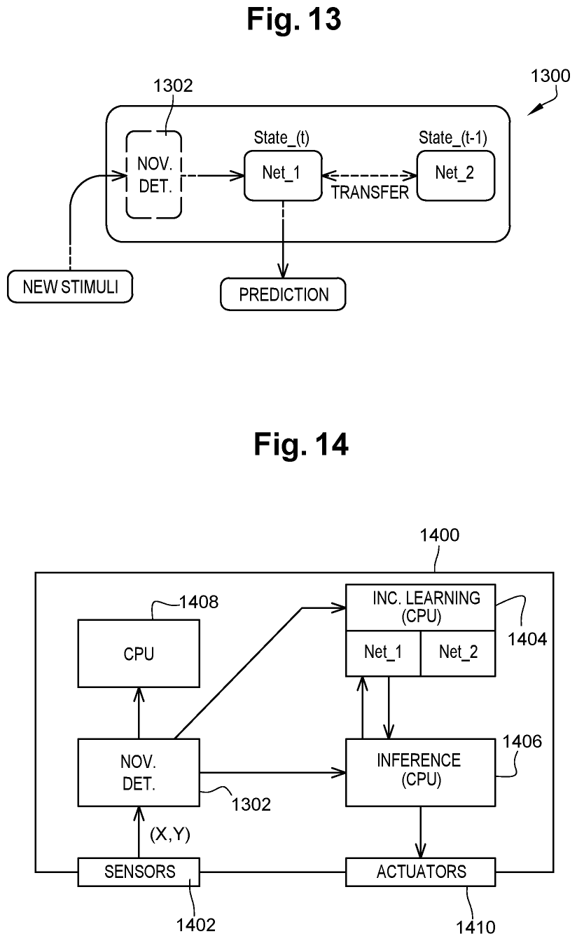

The method of FIG. 3 for example corresponds to a training phase of the ANN during which the ANN is trained, for example by supervised learning. After the stage 306 of FIG. 3, it may be desirable to implement a new training operation involving new stimuli. However, doing so may again risk causing the previously learnt information to be lost from Net_1. Therefore, the process of stages 304 and 306 of FIG. 3 of storing the state of Net_1 to Net_2, and of performing the new training along side training based on old memories, can be repeated when new stimuli is to be trained. Furthermore, after training and during the inference phase of the ANN, it may be desirable to permit incremental learning, such that new classes of data samples can continue to be learn and handled by the system. Solutions permitting new training phases and/or incremental learning will now be described in more detail with reference to FIGS. 13 to 16.

FIG. 13 schematically illustrates a system 1300 for retaining old memories in an ANN according to yet a further example embodiment of the present disclosure. Net_1 is assumed to have a state State(t), which is for example the state State_2, or a later state of the ANN, and Net_2 is assumed to have a state State_(t-1), which is a previously stored state of Net_1, which is for example the state State_1, or a later state. The system 1300 also comprises a novelty detector (NOV. DET.) 1302. New stimuli data (NEW STIMULI) is for example received by the novelty detector 1302, before being applied to Net_1.

The novelty detector 1302 is for example implemented in hardware and/or by software executed by a processing system, such as the computing system 500 of FIG. 5. The novelty detector 1302 is for example configured to detect when an input data sample is sufficiently distant from past data samples that it should be considered to correspond to a new class to be learnt by the ANN. Examples of novelty detectors have been proposed in the prior art, and are well known to those skilled in the art. For example, a novelty detector can be based on a calculation of a Euclidean distance. Novelty detectors are described in more detail in the publication by Marco A. F. Pimentel et al. entitled “A review of novelty detection”, Signal Processing 99 (2014) 215-249.

In operation, when the system 1300 receives new stimuli, the novelty detector 1302 is configured to detect whether the stimuli falls within the classes that are already known to the system. If so, the new sample is for example passed to Net_1 in order for an input label to be predicted, as represented in FIG. 13 by a prediction output (PREDICTION) of Net_1. Alternatively, if the new stimuli data is detected as a novel sample from a new class not already known to the system, the novelty detector 1302 for example alerts the system, which causes the state State_(t) of Net_1 to be stored to Net_2, and then the new stimuli is learnt by Net_1 while also taking into account pseudo samples generated by Net_2.

Such a method of novelty detection could also be applied to recurrent neural networks (RNN) for processing dynamic data, e.g. data that varies over time, such as audio or video data.

FIG. 14 illustrates a hardware system 1400 according to an example embodiment of the present disclosure. The system 1400 for example comprises one or more sensors (SENSORS) 1402, which for example comprise one or more image sensors, depth sensors, heat sensors, microphones, or any other type of sensor. The one or more sensors 1402 provide new stimuli data samples to a novelty detector (NOV. DET.) 1302, which is for example the same as the one of FIG. 13. This novelty detector 1302 for example provides the data samples to an incremental learning module (INC. LEARNING) 1404 or to an inference module (INFERENCE) 1406. In some embodiments, the modules 1404 and 1406, and also in some cases the novelty detector 1302, are implemented by a CPU 1408 under control of instructions stored in an instruction memory (not illustrated in FIG. 14). Rather than a CPU, the system 1400 could alternatively or additionally comprise a GPU or NPU.

For example, in the case that the novelty detector 1302 detects that the data sample is from a class that is already known to the system, it provides it to the inference module 1406, where it is only processed by Net_1, for example in order to perform classification. In this case, an output of Net_1 corresponding to a predicted label is for example provided to one or more actuators (ACTUATORS), which are for example controlled based on the predicated label. For example, the actuators could include a robot, such as a robotic arm trained to pull up weeds, or to pick ripe fruit from a tree, or could include automatic steering or breaking systems in a vehicle, or operations of circuit, such as waking up from or entering into a sleep mode.

Alternatively, if the novelty detector 1302 detects that the data sample is not from a known class, the sample is for example processed by the incremental learning module 1404, which for example performs the knowledge transfer from Net_1 to Net_2, and then learns the new sample during a consolidation stage like the stage 306 of FIG. 3. In some embodiments, the sample can then be processed by the inference module 1406.

Incremental learning is a method of machine learning, known to those skilled in the art, whereby input data is continuously used to extend the models knowledge. For example, incremental learning is described in the publication by Rebuffi, Sylvestre-Alvise, et al. entitled “icarl: Incremental classifier and representation learning.”, Proceedings of the IEEE conference on Computer Vision and Pattern Recognition, 2017, and in the publication by Parisi, German I., et al. entitled “Continual lifelong learning with neural networks: A review.”, Neural Networks 113 (2019)54-71.

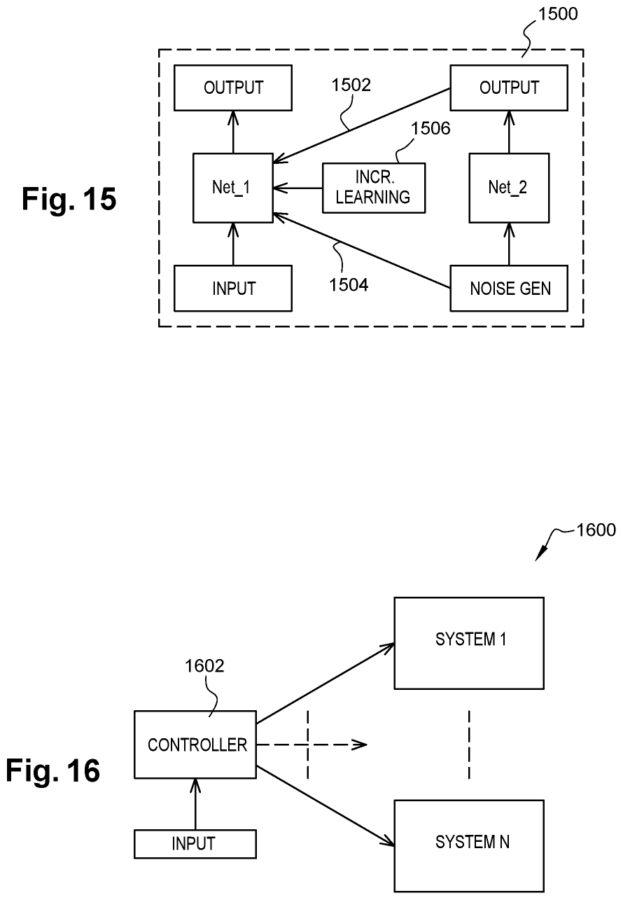

FIG. 15 schematically illustrates an artificial learning system 1500 for incremental learning according to a further example embodiment of the present disclosure. The system 1500 is similar to the system already described above, and is configured to learn new inputs (INPUT) using the ANN Net_1, these inputs corresponding to a certain global distribution. The ANN Net_1 also receives pseudo samples from the ANN Net_2, and generates outputs (OUTPUT).

For example, as shown by an arrow 1502, in some cases the pseudo samples are hetero-associative samples including a pseudo label generated at the output (OUTPUT) of the ANN Net_2.

Additionally or alternatively, as shown by an arrow 1504, the pseudo sample can be auto-associative samples, and in this case Net_1 for example receives the inputs to Net_2 after reinjection and the corresponding outputs of Net_2.

An incremental learning module (INCR. LEARNING) 1506 is for example configured to control the ANN Net_1 to learn new input samples of the global distribution in an incremental fashion as known by those skilled in the art.

Thus, the system of FIG. 15 is a dual model system based on the two ANNs Net_1 and Net_2. If it is detected that a new input sample comes from a new distribution outside the global distribution already learnt by the system 1500, the dual model system can be discretized, as will now be described in more detail with reference to FIG. 16.

FIG. 16 schematically illustrates an artificial learning system 1600 implementing a plurality of learning models. The system 1600 is for example implemented in hardware and/or in software as explained in reference to FIG. 5.

The system 1600 comprises a controller (CONTROLLER) 1602 and a plurality of systems SYSTEM 1 to SYSTEM N, each corresponding to a system similar to the system 1500 of FIG. 15. The number N of systems increases as new samples from new distributions are presented to the system 1600, and can for example reach any limit defined by the available hardware resources.

The controller 1602 is for example configured to receive the new input samples (INPUT), and detect whether the sample belongs to a known distribution, or to a new distribution. For example, this involves detecting whether the sample belongs to a new class, or a known existing class. An example of techniques that can be used for detecting whether a sample belongs to a new distribution or class are described in more detail in the publication by Mandelbaum, Amit, and Daphna Weinshall entitled “Distance-based confidence score for neural network classifiers.”, arXiv preprint arXiv:1709.09844 (2017).

If the sample belongs to a distribution that has already been learnt, the controller 1602 is for example configured to supply the new sample to the system corresponding to this learnt distribution, where it is learnt by that system as described above with reference to FIG. 15. In particular, the new sample is for example incrementally learnt without forgetting previous samples from the same distribution.

Alternatively, if the sample belongs to a new distribution that has not been previously learnt, a new double model system, in other words a new system similar to that of FIG. 15, is created by the controller 1602, and forms a new system of the set of systems SYSTEM 1 to SYSTEM N. The new sample is provided to the new system, and learnt in a traditional manner.

In some embodiments, each different classification may be treated as a different distribution, such that each of the systems SYSTEM 1 to SYSTEM N only handles a single class. In such a case, the systems may have no classification function, as there is no longer any class boundary to be learnt within each system SYSTEM 1 to SYSTEM N.

An advantage of the embodiments described herein is that catastrophic forgetting in an ANN can be at least partially mitigated.

Furthermore, an advantage of the homogenization stage 302 of FIG. 3 is that the present inventors have found that this has the effect of stabilizing the learning process. Since in this homogenization step there is no function or class boundary to be learnt from Net_2, this result may appear counterintuitive. Indeed, Net_2 does not generate interpretable outcomes. Furthermore, the outcomes look like Gaussian noise and do not hold any particular understandable structure. However, such an unstructured characterization holds information about the structure of the Net_2 virgin state State_0, as will now be explained in more detail.

We can examine the particularity of this event by considering the internal parameter changes between two different states. We will consider first the case when Net_1 learns just the first new stimuli without the Net_2 virgin state. When learning the new stimuli, Net_1 will optimize all the parameters to fit the incoming data. As the problem that Net_1 must resolve, which is to learn the class boundaries for one or more classes, is straightforward, Net_1 will probably converge to close to a global minimum. That is, the parameters will change a lot between the Net_1 virgin state and the optimal point that solves the problem. Then, during the consolidation step, Net_1 should learn a new class along with its previous state from Net_2. The optimization in order to learn the incoming data (memories and new classes) leads to relatively large changes to the parameters. In other words, the valley point, in which Net_1 was, is far from the valley point that it should reach. Moreover, the drift along the internal solution space is much more complicated because the memories act as a spring. As Net_1 is close to a global minimum, the only thing holding Net_1 back from reaching a new optimal solution is the memories from Net_2. Even if Net_1 struggles to satisfy the solution, sooner or later it will find a valid parameter combination. However, the effort risks leading to a loss in stability.

On the other hand, when Net_1 learns the first new stimuli along with the characterization of the virgin state from Net_2, the dual system becomes stable for incremental learning. We consider here that the virgin state of an ANN is the more stable state because of its high internal entropy. In other words, the parameters are randomly and independently initialized and do not fit any hidden function. Net_1, when learning the pseudo data from Net_2 and the new stimuli, then finds an optimal solution that is the closest one to the virgin state. Thus, the parameters do not evolve too much when building the class boundary. In fact, by learning the virgin state, Net_1 looks for a parameter combination that allows it to stay in its stable virgin state while satisfying the conditions. That is to say, Net_1 will change the parameters by the minimum amount in order to fit the function. At the same time, learning the characterization of the virgin state prevents Net_1 from finding a nearby global minimum for the incoming data. This latter point suggests that the virgin state acts as a regularization that helps a generalization by Net_1 by balancing the parameter changes.

Since the new state of Net_1 after the homogenization step is transferred to Net_2, the learned virgin state will also be transferred. In other words, the virgin state will be maintained and replicated along the learning lifetime of the dual system, and as the model replicates and classifies inputs, it is able to re-generate the virgin state. Then, for every new Net_1 learning phase, Net_2 not only generates the class boundaries of the learned classes but also the characterization of the virgin state.

Various embodiments and variants have been described. Those skilled in the art will understand that certain features of these embodiments can be combined and other variants will readily occur to those skilled in the art.

For example, while examples of a classification function have been described, it will be apparent to those skilled in the art that, in alternative embodiments, the principles described herein could be applied to other types of learning function that are not necessarily a classification function.

Finally, the practical implementation of the embodiments and variants described herein is within the capabilities of those skilled in the art based on the functional description provided hereinabove. For example, while examples have been described based on multi-layer perceptron ANN architectures, the description of the method proposed to resolve catastrophic forgetting applies more generally to any deep learning neural network (DNN) and convolutional neural networks (CNN). For example, a dense part of a DNN or a CNN is constituted by an MLP as presented above. Furthermore, the principles described herein could also be applied to other families of neural networks including, but not restricted to, recurrent neural networks, reinforcement learning networks, etc. The described embodiments also apply to hardware neural architectures, such as Neural Processing Units, Tensor Processing Units, Memristors, etc.

1. A method comprising:
training an artificial neural network by:
initially training a first artificial neural network with first input data and first pseudo data, wherein the first pseudo data is or was generated by a second artificial neural network in a virgin state, or by the first artificial neural network while in a virgin state;
generating second pseudo data using the first artificial neural network, or using the second artificial neural network following at least partially transferring knowledge from the first artificial neural network to the second artificial neural network; and
training the first artificial neural network, or another artificial neural network, with the second pseudo data and second input data; and
using the trained first or further artificial neural network in a hardware system to control one or more actuators.

2. The method of claim 1, further comprising, prior to initially training the first artificial neural network:
generating the first pseudo data using the first artificial neural network while in the virgin state; and
storing the first pseudo data to a memory.

3. The method of claim 2, wherein the second pseudo data is generated by the first artificial neural network and stored to the memory prior to training the first artificial neural network with the second pseudo data and the second input data.

4. The method of claim 1, further comprising, prior to generating the second pseudo data, at least partially transferring knowledge held by the first artificial neural network to the second artificial neural network, wherein the second pseudo data is generated using the second artificial neural network, wherein the training of the first artificial neural network with the second pseudo data and second input data is performed at least partially in parallel with the generation of pseudo data by the second artificial neural network.

5. The method of claim 1, further comprising:
detecting, using a novelty detector, whether one or more third input data samples correspond to a class that is already known to the first artificial neural network; and
if the one or more third input data samples do not correspond to a class that is already known, generating third pseudo data using the first artificial neural network, or using the second artificial neural network following at least partially transferring knowledge again from the first artificial neural network to the second artificial neural network, and training the first artificial neural network with the third pseudo data and third input data samples.

6. The method of claim 1, further comprising:
detecting, by a controller, whether one or more third input data samples correspond to a new distribution not already learnt by the first artificial neural network; and
if the one or more third input data samples do correspond to the new distribution, creating a new system for learning the one or more third input data samples, the new system comprising at least a further first artificial neural network.

7. The method of claim 1, wherein generating the first pseudo data comprises:
a) injecting a first random sample into the first or second artificial neural network, wherein the first or second artificial neural network is configured to implement at least an auto-associative function for replicating input samples at one or more of its outputs, at least some of the replicated input samples present at the outputs forming the first pseudo data.

8. The method of claim 1, wherein generating the second pseudo data comprises:
a) injecting a second sample into the first or second artificial neural network, wherein the first or second artificial neural network is configured to implement at least an auto-associative function for replicating input samples at one or more of its outputs, at least some of the replicated input samples present at the outputs forming the second pseudo data, wherein the first sample is a random sample or a real sample.

9. The method of claim 7, wherein generating the first and/or second pseudo data further comprises:
b) reinjecting a pseudo sample, generated based on the replicated sample present at the one or more outputs of the first or second artificial neural network, into the first or second artificial neural network in order to generate a new replicated sample at the one or more outputs; and
c) repeating b) one or more times to generate a plurality of reinjected pseudo samples;
wherein the first and/or second pseudo data comprises at least two of said reinjected pseudo samples originating from the same first or second sample and corresponding output values generated by the first or second artificial neural network.

10. The method of claim 9, wherein the first and/or second artificial neural network implements a learning function, which is for example a classification function, and wherein the corresponding output values of the first pseudo data comprise pseudo labels generated by the learning function based on the reinjected pseudo samples.

11. The method of claim 1, wherein using the trained first or further artificial neural network to control one or more actuators comprises:
providing, by one or more sensors, one or more third input data samples to a novelty detector;
detecting whether the one or more third input data samples correspond to a class that is already known to the first artificial neural network, and if so, providing the third input data samples to an inference module comprising the trained first or further artificial neural network in order to generate a predicted label for controlling the one or more actuators.

12. The method of claim 11, further comprising, if the one or more third input data samples do not correspond to a class that is already known to the first artificial neural network:
generating third pseudo data using the first artificial neural network, or using the second artificial neural network following at least partially transferring knowledge again from the first artificial neural network to the second artificial neural network; and
training the first artificial neural network with the third pseudo data and third input data samples.

13. A system comprising:
a first artificial neural network;
either a second artificial neural network in a virgin state and configured to generate first pseudo data, or a memory storing the first pseudo data generated by the first artificial neural network while in a virgin state;
one or more actuators; and
one or more circuits or processors configured to generate old memories for use in training the first artificial neural network by:
initially training the first artificial neural network with first input data and with the first pseudo data;
generating second pseudo data using the first artificial neural network, or using the second artificial neural network following at least partially transferring knowledge from the first artificial neural network to the second artificial neural network;
training the first artificial neural network, or another artificial neural network, with the second pseudo data and second input data; and
controlling the one or more actuators using the trained first or further artificial neural network.

14. The system of claim 13, further comprising a novelty detector configured to:
detect whether one or more third input data samples correspond to a class that is already known to the first artificial neural network; wherein, if the one or more third input data samples do not correspond to a class that is already known, the one or more circuits or processors is further configured to:
generate third pseudo data using the first artificial neural network, or using the second artificial neural network following at least partially transferring knowledge again from the first artificial neural network to the second artificial neural network; and
training the first artificial neural network with the third pseudo data and third input data samples.

15. The system of claim 14, further comprising one or more sensors configured to provide the one or more third input data samples.

16. The system of claim 14, wherein, if the one or more third input data samples correspond to a class that is already known, the one or more circuits or processors is further configured to provide the third input data samples to an inference module comprising the trained first or further artificial neural network in order to generate a predicted label for controlling the one or more actuators.

17. The system of claim 13, further comprising a controller configured to:
detect whether one or more third input data samples correspond to a new distribution not already learnt by the first artificial neural network; and
if the one or more third input data samples correspond to the new distribution, to create a new system for learning the one or more third input data samples, the new system comprising at least a further first artificial neural network.

18. The system of claim 13, wherein the one or more circuits or processors is configured to generate the first pseudo data by:
a) injecting a first random sample into the first or second artificial neural network, wherein the first or second artificial neural network is configured to implement at least an auto-associative function for replicating input samples at one or more of its outputs, the replicated input samples present at the outputs forming the first pseudo data.

19. The system of claim 13, wherein the one or more circuits or processors is configured to generate the second pseudo data by:
a) injecting a second sample into the first or second artificial neural network, wherein the first or second artificial neural network is configured to implement at least an auto-associative function for replicating input samples at one or more of its outputs, at least some of the replicated input samples present at the outputs forming the second pseudo data, wherein the first sample is a random sample or a real sample.
